(19) United States
(12) Patent Application Publication
(10) Pub. No.: US 2014/0054996 A1
(43) Pub. Date: Feb. 27, 2014

(54) ELECTRIC MOTOR AND MOTOR/GEAR UNIT AND VARIABLE-LENGTH DRIVE MEANS HAVING SUCH AN ELECTRIC MOTOR

(71) Applicant: Stabilus GmbH, Koblenz (DE)

(72) Inventor: Andreas Ritter, Hilgert (DE)

(73) Assignee: Stabilus GmbH, Koblenz (DE)

(21) Appl. No.: 13/970,846

(22) Filed: Aug. 20, 2013

(30) Foreign Application Priority Data
Aug. 21, 2012 (DE) 10 2012 214 850.7

(51) Int. Cl. H02K 5/00

(52) U.S. Cl. CPC H02K 5/00
USPC 310/91

(57) ABSTRACT

The invention relates to an electric motor (10) having a casing (12) and a rotor (18) which has a rotor shaft (26) with an axis (A), wherein the rotor shaft (26) is guided outside the casing (12), by means of one of its ends, through an opening (28) which is provided in a wall (30) of the casing (12) that extends at a right angle to the axial direction (A) and with which a bearing element (38) is associated, wherein the bearing element (38) bears the rotor shaft (26) such that it can rotate. According to the invention, the bearing element (38) is received in a depression (32) that is made in the wall (30) that extends at a right angle to the axial direction (A), wherein a damping element (54) is provided between a peripheral wall of the depression (32) and the bearing element (38). The invention further relates to a motor/gear unit (10/58) and a variable-length drive means having an electric motor (10) of this kind.

The invention relates to an electric motor, including a casing and a rotor which has a rotor shaft with an axis, wherein the rotor shaft is guided outside the casing, by means of one of its ends, through an opening which is provided in a wall of the casing that extends at a right angle to the axial direction and with which a bearing element is associated, wherein the bearing element bears the rotor shaft such that it can rotate.

Electric motors of this kind are used for example in electromechanical drive devices, which are sold by the Applicant under the name POWERISE® and have been installed for example in vehicles manufactured in 2011, in the models Audi A6 Limousine and Audi A7.

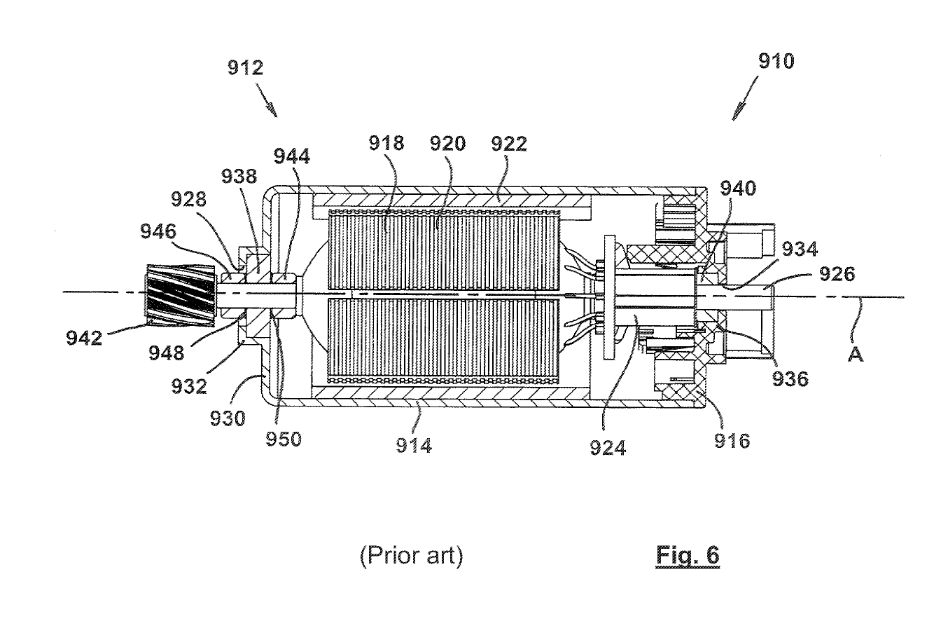

FIG. 6 shows a longitudinal section through a known electric motor of this kind. The electric motor 910 includes a casing 912 which is composed of a cup-shaped part 914 and a cover part 916. A rotor 918 is received in the casing 912. Rotor windings 920 of the rotor 918 cooperate in a manner known per se with permanently magnetic stator magnets 922 to rotate the rotor 918 in relation to the casing 912 when supplied with electrical direct current in alternating manner by a commutator 924. A rotor shaft 926 of the rotor 918 is guided outside the casing 912, by means of its left-hand end as seen in FIG. 6, through an opening 928 which is made in a wall 930, or to be more precise in a depression 932 in this wall 930, of the cup-shaped part 914, wherein the wall 930 extends at a right angle to the axis A of the rotor shaft 926. Similarly, the right-hand end as seen in FIG. 6 of the rotor shaft 926 is guided outside the casing 912 through an opening 934 in the cover part 916. To be more precise, the opening 934 is also made in a depression 936 in the cover part 916.

Bearing elements 938 and 940 made of sintered metal are pressed into the depressions 932 and 936 respectively and these bear the rotor shaft 926 and hence the rotor 918 in the casing 912, such that they can rotate. In order to withstand forces acting in the direction of the axis A, which may arise for example from cooperation between the pinion 942 arranged on the rotor shaft 926 and a gear unit (not illustrated) downstream of the electric motor 910, two shaft collars 942 and 944 are secured on the left-hand end portion, as seen in FIG. 6, of the rotor shaft 926 and receive the bearing element 938 between them. To reduce sliding friction between the bearing element 938 and the shaft collars 942, 944, a respective thrust washer 948 and 950 made of synthetic material is arranged between the bearing element 938 and each of the shaft collars 942, 944. A further thrust washer 952, also made of synthetic material, is provided between the commutator 924 and the bearing element 940.

In particular when electric motors of this kind are combined with planetary gears, in practice undesirable noise is generated. Although the source of this noise generation is not fully understood, it may well derive from the fact that with this combination no radial forces are exerted by the gear on the rotor shaft, with the result that the rotor shaft can move freely to and fro in the bearing elements because there is bearing play.

It is therefore the object of the invention to further develop electric motors of the type mentioned at the outset such that less noisy operation is made possible.

This object is achieved by an electric motor of the type mentioned at the outset in which the bearing element is received in a depression that is made in the wall that extends at a right angle to the axial direction, wherein a damping element is provided between the peripheral wall of the depression and the bearing element. The damping element provides a kind of “floating” bearing which, when the rotor shaft impacts against the bearing element in the radial direction, takes up the impact and absorbs it, as a result of which the noise generated is reduced.

According to a variant further development, the rotor shaft may be guided outside the casing, by means of its other end, through a further opening, wherein a further bearing element which bears the rotor shaft such that it can rotate is associated with the further opening. According to a variant further development which presents an alternative thereto, it is also possible, however, for the rotor shaft to be borne such that it can rotate, by means of its other end, in a further wall in the casing that extends at a right angle to the axial direction, wherein a further bearing element which bears the rotor shaft such that it can rotate is associated with the other end of the rotor shaft. In both variant further developments, the construction according to the invention of the one bearing element may also be implemented in the further bearing element, that is to say that the further bearing element may also be received in a depression that is made in the further wall that extends at a right angle to the axial direction, wherein a further damping element is provided between a peripheral wall of the depression and the bearing element.

The damping element and/or the further damping element may preferably be an elastic, preferably rubber-elastic, element. In this way, the desired damping properties may be provided in simple manner. It is further advantageous if the damping element and/or the further damping element is/are of annular construction, since in this case the bearing element can be damped over its entire periphery, that is to say in all radial directions.

A commercially available O ring is an example of a damping element that combines both of the two above-mentioned features within it. However, the same applies to annular damping elements made of an elastic material which are of a different cross-sectional shape. For example, the damping element or the further damping element may also have a rectangular cross section.

As a further development of the invention, it is proposed that the damping element or the further damping element include(s) a portion that extends substantially at a right angle to the axial direction. In the mounted condition, this portion is arranged between the bearing element or the further bearing element and the base of the depression receiving it, and may thus also provide damping of any movements in the direction of the rotor shaft axis. In addition or as an alternative, the possibility of compressing this portion may also be used to compensate for manufacturing tolerances.

In order to be able to minimise the bearing play mentioned above or even to reduce it to zero, it is advantageous if the bearing element and/or the further bearing element is/are constructed to have a slit in the axial direction, wherein the at least one slit extends over at least part of the length of the bearing element or the further bearing element, as measured in the axial direction. The force which narrows the slit(s) and hence minimises or eliminates the bearing play may for example be generated by radial compression of the damping element or the further damping element when it is inserted in its receiving depression. When an annular damping element is used, however, this force may be generated purely by the cooperation of the bearing element with the damping element mounted thereon, or of the further bearing element with the further damping element mounted thereon.

As a further development of the invention, it may be provided for the rotor to be supported directly or indirectly in the axial direction on the bearing element and/or the further bearing element. For example the rotor may be supported on its side facing the commutator and directly by way of the commutator against the bearing element associated with this end of the rotor shaft, and/or the rotor may be supported on its side remote from the commutator, by way of a shaft collar, against the bearing element associated with this end of the rotor shaft. In this way, the rotor may be supported, in relation to the pinion provided on the output side of the rotor shaft, in the pushing direction on the commutator side and in the pulling direction on the side of the rotor remote from the commutator. Compared with the conventional embodiment illustrated in FIG. 6, it is thus possible to dispense with the shaft collar 946, which further simplifies the construction of the electric motor according to the invention. Furthermore, the overall length of the electric motor may be reduced as a result of this measure.

In a manner known per se, it is also possible in the case of the electric motor according to the invention for the casing to include a part constructed in the manner of a cup and a cover part that closes this. Further, the casing may be constructed as a pole housing.

In a further development of the invention, the bearing element and/or the further bearing element may be formed by a material that reduces noise, for example a synthetic material. The fact that a rotor shaft that, because of bearing play, may move to and fro freely in the bearing element is borne in a bearing element made of a material of this kind is in itself the opposite of what those skilled in the art would expect, since these materials usually have a substantially lower resistance to mechanical load than, for example, the sintered metal used in conventional bearing elements. Those skilled in the art would therefore assume that, if this material is selected, the bearing elements cannot be prevented from failing after only a short period of operation. It is the achievement of the inventors that they recognised that this risk of damage is drastically reduced or can even be entirely eliminated if the bearing element is for its part borne as though “floating” in the casing, by providing the damping element between the peripheral wall of the depression receiving the bearing element and the bearing element. This further development of the electric motor can also moreover simplify the construction of the electric motor, since as a result of this further development there is no longer any need to provide synthetic thrust washers. Possible material for manufacturing the one bearing element and/or the further bearing element are for example POM (polyoxymethylene) or indeed PAI (polyamide-imide, such as Torlon®, in particular Torlon® 4301) or another synthetic material having high heat resistance.

According to a second aspect, the invention relates to a motor/gear unit having an electric motor according to the invention and a planetary gear which is in engagement with a pinion of the electric motor according to the invention on the output side.

And according to a third aspect, finally, the invention also relates to a variable-length drive means, in particular for a closing element of a vehicle, for example a boot lid, hatchback, door or the like, including a rotary drive, a spindle drive having a threaded spindle and a threaded nut, wherein the threaded spindle and the threaded nut are in threaded engagement with one another and may be displaced axially in relation to one another in response to rotation of the rotary drive, and wherein the rotary drive includes an electric motor according to the invention and/or a motor/gear unit according to the invention.

The invention will be described in more detail below by way of exemplary embodiments, with reference to the attached drawings, in which:

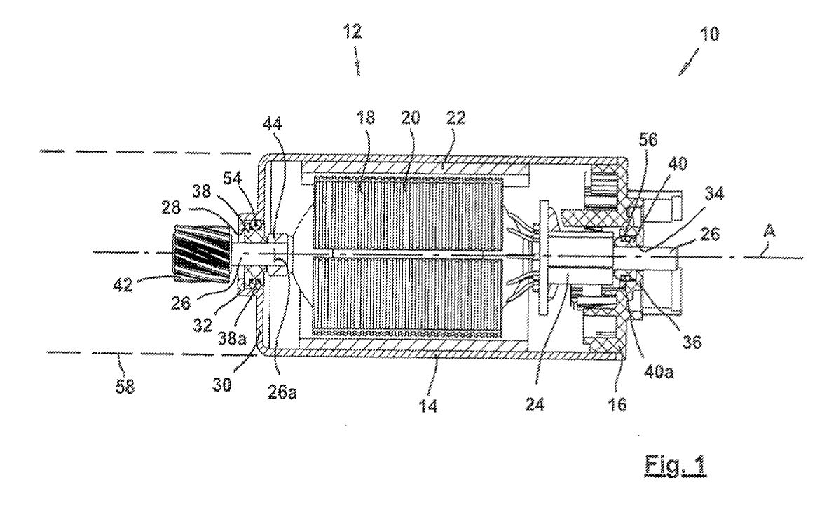

FIG. 1 shows a longitudinal section of a first embodiment of an electric motor according to the invention;

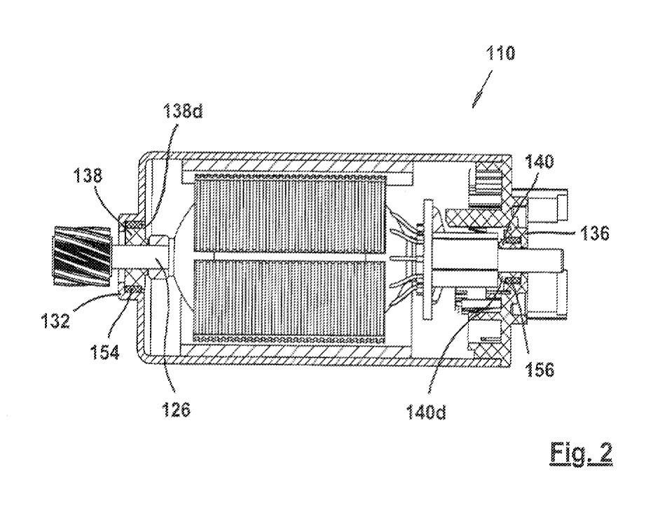

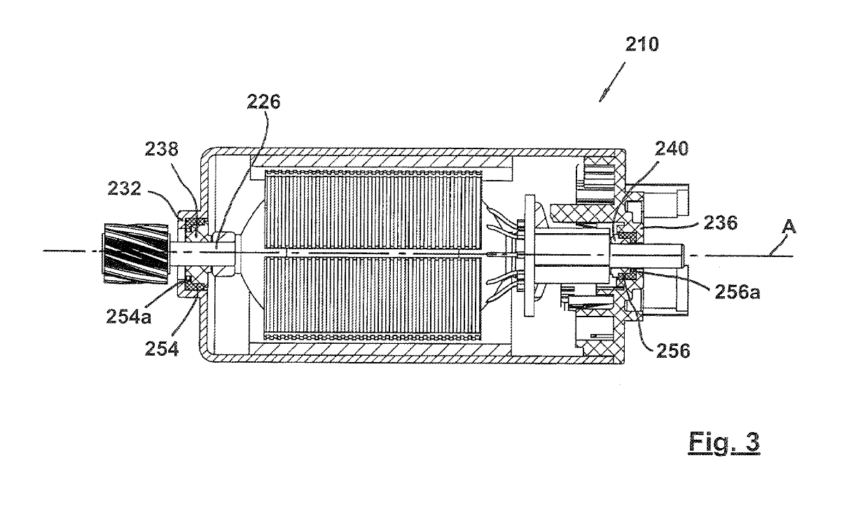

FIGS. 2 and 3 show views, similar to FIG. 1, of a second embodiment (FIG. 2) and a third embodiment (FIG. 3) respectively of an electric motor according to the invention;

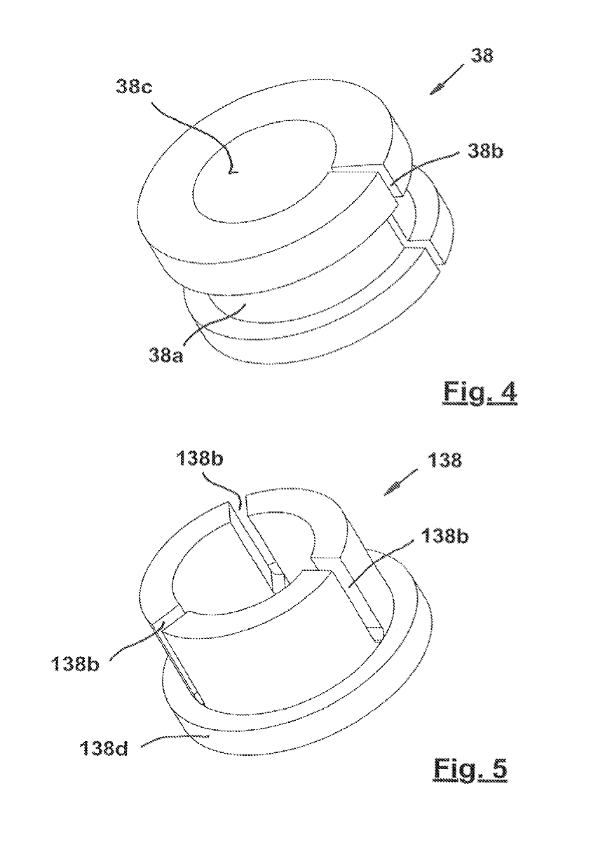

FIGS. 4 and 5 show perspective views of two variant embodiments of bearing elements having a slit; and

FIG. 6 shows a view, similar to FIG. 1, of an electric motor of the prior art.

FIG. 1 illustrates a longitudinal section of a first embodiment of an electric motor 10 according to the invention. The electric motor 10 includes a casing 12 which is composed of a cup-shaped part 14 and a cover part 16. A rotor 18 is received in the casing 12. Rotor windings 20 of the rotor 18 cooperate in a manner known per se with permanently magnetic stator magnets 22 to rotate the rotor 18 in relation to the casing 12 when supplied with electrical direct current in alternating manner by a commutator 24. A rotor shaft 26 of the rotor 18 is guided outside the casing 12, by means of its left-hand end as seen in FIG. 1, through an opening 28 which is made in a wall 30, or to be more precise in a depression 32 in this wall 30, of the cup-shaped part 14, wherein the wall 30 extends at a right angle to the axis A of the rotor shaft 26. Similarly, the right-hand end as seen in FIG. 1 of the rotor shaft 26 is guided outside the casing 12 through an opening 34 in a depression 36 in the cover part 16.

Two bearing elements are received in the depressions 32 and 36, in particular one bearing element 38 on the side of the rotor 18 remote from the commutator 24, in the depression 32, and a further bearing element 40 on the side of the rotor 18 facing the commutator 24, in the depression 36. Both bearing elements 38, 40 have a peripheral groove 38a and 40a respectively, in which a damping element 54 or 56 respectively is received. Because of these damping elements 54, 56, when the rotor shaft 26 exerts radial forces on the bearing elements 38, 40, they can yield to these forces by compressing the damping elements 54, 56. As a result of this, the load on the bearing elements 38, 40 may be reduced. The damping elements 54, 56 damp the radial forces such that they only pass on to the casing 12 a small proportion of the forces originally introduced to the bearing elements 38, 40. By comparison with the conventional electric motor 910 illustrated in FIG. 6, this results in a considerable reduction in the noise generated.

In the embodiment illustrated in FIG. 1, the damping elements 54, 56 both take the form of O rings made of an elastic, preferably rubber-elastic, material. Because of their annular construction, the damping elements 54, 56 may reliably take up and damp radial forces, regardless of the actual orientation in each case.

As illustrated in FIG. 4, the bearing element 38 may be constructed to have a slit, wherein the slit 38b according to FIG. 4 extends over the entire length of the bearing element 38. This construction having a slit makes it possible, in particular in cooperation with an annular damping element 54 of suitable construction, for the bearing element 38 to be compressed by the damping element 54, narrowing the slit 38b, until it bears, by means of its inner peripheral wall 38c, with substantially no play against the outer peripheral surface 26a of the rotor shaft 26. By eliminating the play between the rotor shaft 26 and the bearing element 38, it is possible to prevent the rotor shaft 26 from knocking against the bearing element 38 during operation. On the one hand this reduces the mechanical load on the bearing element 38 and hence the risk of damage to the bearing element 38, and on the other it reduces the noise generated. Naturally, the bearing element 40 may also be similarly constructed to have a slit.

However, it is also possible for axial forces to act on the electric motor 10, these axial forces being caused for example by the cooperation of the pinion 42 that is arranged on the rotor shaft 26 with a gear unit 58, merely indicated by dashed lines, which is downstream of the electric motor 10 and preferably includes a planetary gear. In the embodiment according to FIG. 1, these axial forces may be withstood on the one hand in that the commutator 24 bears directly against the bearing element 40 (pushing direction) and on the other in that a shaft collar 44 bears directly against the bearing element 38 (pulling direction). This direct bearing—that is to say this bearing requiring no intermediate placement of thrust washers—may for example be made possible if the bearing elements 38, 40 are made of synthetic material. Because the thrust washers 48, 50, 52 are omitted, the construction of the electric motor 10 according to the invention is simplified by comparison with the electric motor 910 of the prior art.

FIG. 2 illustrates a second embodiment of an electric motor according to the invention which substantially corresponds to the embodiment according to FIG. 1. Here, similar parts in FIG. 2 are provided with the same reference numerals as in FIG. 1 but incremented by 100. Moreover, the electric motor 110 according to FIG. 2 is only described below to the extent that it differs from the electric motor 10 according to FIG. 1, whereof the description is otherwise hereby explicitly referenced.

The electric motor 110 according to FIG. 2 differs from the electric motor 10 according to FIG. 1, as a first point, in that the damping elements 154 and 156 have a rectangular cross section. In this way, they already, in a condition in which no radial forces are exerted on the bearing elements 138 and 140 respectively, bear both against the associated bearing element 138 and 140 respectively and against the peripheral wall of the depression 132 and 136 respectively, by means of a relatively large bearing surface. As a result of this, even if there are small radial movements of the bearing elements 138, 140, a greater volume of damping element is compressed, compared with the circular cross section of the damping elements 54, 56 according to FIG. 1. Thus, compared with the embodiment according to FIG. 1, a harder damping characteristic is produced.

Naturally, by using annular damping elements having an elliptical cross section and by a suitable selection of the eccentricity of the ellipse, it is also possible for intermediate stages of damping characteristic to be achieved. Moreover, the damping characteristic may also be influenced by the selection of the material of which the damping elements are made.

As a second point, the embodiment of FIG. 2 differs from that of FIG. 1 in that the bearing elements 138, 140 have no peripheral groove in which the damping elements 154, 156 are arranged, but only an annular flange 138d (see also FIG. 5) and 140d respectively, which in the mounted condition is arranged on the side of the bearing element 138, 140 remote from the base of the depression 132 and 136 respectively. The damping elements 154 and 156 are thus held between this annular flange 138d and 140d respectively and the base of the depression 132 and 136 respectively.

The bearing elements 138, 140 of the embodiment according to FIG. 2 may also be constructed to have a slit (see also FIG. 5). Here, there are further differences between the embodiments of FIGS. 1 and 2 in that on the one hand a plurality of slits 138b is arranged distributed, preferably evenly distributed, over the periphery of the bearing element 138, and on the other the slits 138b do not extend over the entire length of the bearing element 138. Nonetheless, the bearing play between the rotor shaft 126 and the bearing element 138 may still be reduced to zero with this variant embodiment. As already mentioned, it is also possible for the bearing element 140 to be constructed similarly.

FIG. 3 illustrates a third embodiment of an electric motor according to the invention which substantially corresponds to the embodiment according to FIG. 2. For this reason, similar parts in FIG. 3 are provided with the same reference numerals as in FIG. 2 but incremented by 100, that is to say that by comparison with FIG. 1 they are incremented by 200. Moreover, the electric motor 210 according to FIG. 3 is only described below to the extent that it differs from the electric motor 110 according to FIG. 2, whereof the description is otherwise hereby explicitly referenced, in particular also including the reference to the description of the embodiment according to FIG. 1.

The electric motor 210 according to FIG. 3 differs from the electric motor 110 according to FIG. 2 in that the damping elements 254, 256 additionally have a portion 254a, 256a which extends substantially at a right angle to the axis A, and in that the bearing elements 238, 240 are constructed to be somewhat shorter in the axial direction in order to provide sufficient overall space in the depression 232 and 236 respectively to receive this portion 254a and 256a respectively between the bearing element 238 and 240 respectively and the base of the depression 232 and 236 respectively. As a result of this arrangement, in the mounted condition the portion 254a and 256a respectively may provide damping of any movements in the direction of the axis A of the rotor shaft 226. In addition, it may also be used to compensate for manufacturing tolerances.

The motor/gear unit 10/58 indicated in FIG. 1 may be used for example as a rotary drive in variable-length drive means as used for example in the automotive sector for the motorised opening and closing of closing elements of a motor vehicle, in particular for the motorised opening and closing of hatchbacks, boot lids, doors and the like. The construction of these variable-length drive means having a rotary drive and a spindle drive having a threaded spindle and a threaded nut which are in threaded engagement with one another and may be displaced axially in relation to one another in response to rotation of the rotary drive is generally known, and for this reason is not described separately here. Purely by way of example, reference is made to the variable-length drive means sold by the Applicant under the name POWERISE®.

1. An electric motor, comprising:
a casing and
a rotor which has a rotor shaft with an axis,
wherein the rotor shaft is guided outside the casing, by means of one of its ends, through an opening which is provided in a wall of the casing that extends at a right angle to the axial direction and with which a bearing element is associated, wherein the bearing element bears the rotor shaft such that it can rotate,
wherein the bearing element is received in a depression that is made in the wall that extends at a right angle to the axial direction, wherein a damping element is provided between a peripheral wall of the depression and the bearing element.

2. An electric motor according to claim 1, wherein the rotor shaft is guided outside the casing, by means of its other end, through a further opening, wherein a further bearing element which bears the rotor shaft such that it can rotate is associated with the further opening.

3. An electric motor according to claim 1, wherein the rotor shaft is borne such that it can rotate, by means of its other end, in a further wall in the casing that extends at a right angle to the axial direction, wherein a further bearing element which bears the rotor shaft such that it can rotate is associated with the other end of the rotor shaft.

4. An electric motor according to claim 2, wherein the further bearing element is received in a depression that is made in the further wall that extends at a right angle to the axial direction, wherein a further damping element is provided between a peripheral wall of the depression and the further bearing element.

5. An electric motor according claim 1, wherein the damping element and/or the further damping element is an elastic, preferably rubber-elastic, element.

6. An electric motor according to claim 1, wherein the damping element and/or the further damping element is/are of annular construction.

7. An electric motor according to claim 1, wherein the damping element and/or the further damping element include(s) a portion that extends substantially at a right angle to the axial direction.

8. An electric motor according to claim 1, wherein the bearing element and/or the further bearing element is/are constructed to have a slit in the axial direction, wherein the at least one slit extends over at least part of the length of the bearing element or the further bearing element, as measured in the axial direction.

9. An electric motor according to claim 1, wherein the rotor is supported directly or indirectly in the axial direction on the bearing element and/or the further bearing element.

10. An electric motor according to claim 9, wherein the rotor is supported on its side facing the commutator and directly by way of the commutator against the bearing element associated with this end of the rotor shaft, and/or the rotor is supported on its side remote from the commutator, by way of a shaft collar, against the bearing element associated with this end of the rotor shaft.

11. An electric motor according to claim 1, wherein the casing includes a part constructed in the manner of a cup and a cover part that closes this.

12. An electric motor according to claim 1, wherein the casing is constructed as a pole housing.

13. An electric motor according to claim 1, wherein the bearing element and/or the further bearing element are formed by a material that reduces noise, for example a synthetic material.

14. A motor/gear unit comprising:
an electric motor, and
a planetary gear which is in engagement with a pinion of the electric motor on the output side,
wherein the electric motor includes:
a casing, and
a rotor which has a rotor shaft with an axis,
wherein the rotor shaft is guided outside the casing, by means of one of its ends, through an opening which is provided in a wall of the casing that extends at a right angle to the axial direction and with which a bearing element is associated, wherein the bearing element bears the rotor shaft such that it can rotate, and
wherein the bearing element is received in a depression that is made in the wall that extends at a right angle to the axial direction, wherein a damping element is provided between a peripheral wall of the depression and the bearing element.

15. A variable-length drive means, in particular for a closing element of a vehicle, comprising:
a rotary drive,
a spindle drive having a threaded spindle and a threaded nut,
wherein the threaded spindle and the threaded nut are in threaded engagement with one another and may be displaced axially in relation to one another in response to rotation of the rotary drive, and
wherein the rotary drive includes a motor/gear unit including:
a casing, and
a rotor which has a rotor shaft with an axis,
wherein the rotor shaft is guided outside the casing, by means of one of its ends, through an opening which is provided in a wall of the casing that extends at a right angle to the axial direction and with which a bearing element is associated, wherein the bearing element bears the rotor shaft such that it can rotate,
wherein the bearing element is received in a depression that is made in the wall that extends at a right angle to the axial direction, wherein a damping element is provided between a peripheral wall of the depression and the bearing element.
